(19) United States
(12) Patent Application Publication
(10) Pub. No.: US 2009/0015352 A1
(43) Pub. Date: Jan. 15, 2009

(54) FILTER ASSEMBLIES AND COMMUNICATION SYSTEMS BASED THEREON

(75) Inventors: Uhland Goebel, Wila (CH); Marlin Wagner, Pfaffikon (CH)

Correspondence Address: MOETTELI & ASSOCIATES SARL, ST. LEONHARDSTRASSE 4, ST. GALLEN, CH-9000, CH

(73) Assignee: HUBER+SUHNER AG, Herisau (CH)

(21) Appl. No.: 11/576,257

(22) PCT Filed: Oct. 4, 2005
(86) PCT No.: PCT/EP2005/054990

§ 371 Date: Oct. 1, 2008

(30) Foreign Application Priority Data
Oct. 7, 2004 (EP) 04023918.8

(51) Int. Cl. H01P 1/208; H01P 11/00

(52) U.S. Cl. 333/212; 29/600

(57) ABSTRACT

A filter assembly (300) with a plurality of cavities serving as said waveguide resonators is presented. The cavities are arranged at least on two levels (x1, y1; x2, y2) of said filter assembly (300). Two or three molded filter parts (301, 302, 303) define the cavities, when the filter parts (301, 302, 303) are assembled. A first opening in a wall between a first and a second of cavity is provided. Said opening serves as capacitive junction between said first cavity and said second cavity. A second opening is provided in another wall between a third cavity and a fourth cavity, said opening serving as inductive junction. The filter parts (301, 302, 303) are at least partially covered by a metal layer.

The present invention concerns filter structures and communication systems based thereon.

### BACKGROUND ART

In an effort to significantly reduce the overall cost of communication systems, low-cost key-components like high-gain antennas, filters and front-end modules are under development.

A key requirement for higher volume market penetration is a significant reduction of the overall customer premises equipment costs. Typical cost drivers of millimeter wave communications systems, for example, are high-gain antennas, high selectivity filters, and front-end modules. Additionally, assembly and tuning costs are typically very high and require certain RF specific know-how in the respective assembly lines.

Continuously increasing data rates create a demand for Gigabit wireless communications systems for last mile access and enterprise/campus applications, for example. An important component of such a communication system is, as mentioned above, a millimeter wave filter. There is a specific demand to provide small and compact millimeter wave filters to allow for high density integration of electrical functions within available outdoor unit volume.

An important element of such filters are high Q waveguides for guiding the millimeter waves. In conventional filters, milled metal blocks are used to guide the waves. It is obvious, that the milling of metal blocks has limits as far as the complexity of the 3-dimensional structure is concerned. Furthermore, the milling is time consuming since it is a serial process and the shape of the structures tends to vary as the milling tool wears down.

One approach to reduce the cost of milled metal block waveguide structures is to use E-plane and ridge waveguide structures, for example. A more generalized approach for millimeter wave radio cost reduction by closely integrating metallized plastics and Low Temperature Co-Fired Ceramics (LTCC) front-end hybrid modules was presented in by U. Goebel et al. in the paper “A Millimeterwave Communication Outdoor Unit—An Innovative Approach Combining Injection Moulding and LTCC Substrate Techniques”, 29th EuMC 1999, Munich, Germany, Focussed Session on “Front-End architecture for Sensors and Communication Modules” MF-WeD3-4. At this conference, the potential to use—LTCC and the plastic injection molding techniques in a front-end module has been presented. It is a disadvantage of the approach presented in this paper that the assembly process is complex since thermal soldering or thermally supported gluing steps are required.

There is a demand to provide highly precise filters that are easy to manufacture and that fulfill the reproducibility requirements of millimeter and sub-millimeter wave circuits. On the other hand, the respective filters have to function properly, that is they have to satisfy the respective electrical design criteria in particular in the high frequency domain.

### SUMMARY OF THE INVENTION

The present invention is directed to a filter assembly with several waveguide resonators, according to claim 1 and a communication system as claimed in claim 11.

Advantageous embodiments are claimed in the dependent claims.

The present invention is very well suited for realizing diplexer filters for Gigabit wireless applications and for applications operating at even higher frequencies.

According to the present invention, modern high performance thermoplastics and metal plating or metal deposition technologies are combined to obtain high production yield and low cost of assembly.

Two or three plastic molded parts are fabricated in perfect fit and assembled by a glue- and solder-less press-fitting process.

According to the present invention, a very compact outline is achieved by stacking pairs of resonators, which are preferably fabricated as cavities inside a central plastic molded part of the filter assembly.

The foregoing and other objects and advantages of the invention will appear from the following description. In the description reference is made to the accompanying drawings which form a part thereof, and in which there are shown by way of illustration, preferred embodiments of the invention. Such embodiments do not necessarily represent the full scope of the invention, however, and reference is therefore made to the claims herein for interpreting the scope of the invention.

### FIGURES

FIG. 1A: is a perspective view of a first building block, according to the present invention;

FIG. 1B: is a schematic cross-section of the first building block;

FIG. 2A: is a perspective view of a second building block, according to the present invention;

FIG. 2B: is a schematic cross-section of the second building block;

FIG. 3: is a perspective view of a first filter assembly, according to the present invention;

FIG. 4: is a perspective view of a second filter assembly, according to the present invention;

FIG. 5: is diagram showing the 60 GHz frequency band for a FDD wireless Gigabit link, according to the present invention;

FIG. 6A: is a perspective top view of a third filter assembly, according to the present invention;

FIG. 6B: is an exploded top view of the filter assembly of FIG. 6A;

FIG. 6C: is a perspective bottom view of the filter assembly of FIG. 6A;

FIG. 6D: is an exploded bottom view of the filter assembly of FIG. 6A;

FIG. 7: is a schematic block diagram of a communication system, according to the present invention.

### DETAILED DESCRIPTION

### Terms

This section describes several terms used throughout the specification and claims to facilitate discussion of the invention.

Cavities are 3-dimensional areas at least partially surrounded by walls of plastic molded parts, as will become obvious from the description of the various embodiments. A cavity can have any shape or size, as long as it is able to handle a wave, as desired.

The term opening is used to describe a junction or connection between two adjacent cavities or a cavity and a connecting waveguide. In order to be able to make a distinction between openings that connect two cavities that are stacked on each other, the term iris is used. An opening between two cavities on the same level is herein referred to as aperture. This distinction is for sake of clarity only and has no implications or consequences as far as the size, shape or position of the respective openings is concerned.

The word waveguide is used to indicate that the respective structure is designed to guide waves. It is obvious that the size, shape and other properties of the waveguide are at least to some extent dictated or influenced by the wave that is to be guided. In the following reference is made to millimeter and sub-millimeter waves (Giga Hertz frequencies and above), but the principle of the present invention can also be applied to other frequencies.

For sake of simplicity, the 3-dimensional structures are described to have at least two levels. This will help the reader to better understand the orientation and relative positioning of the various parts concerned.

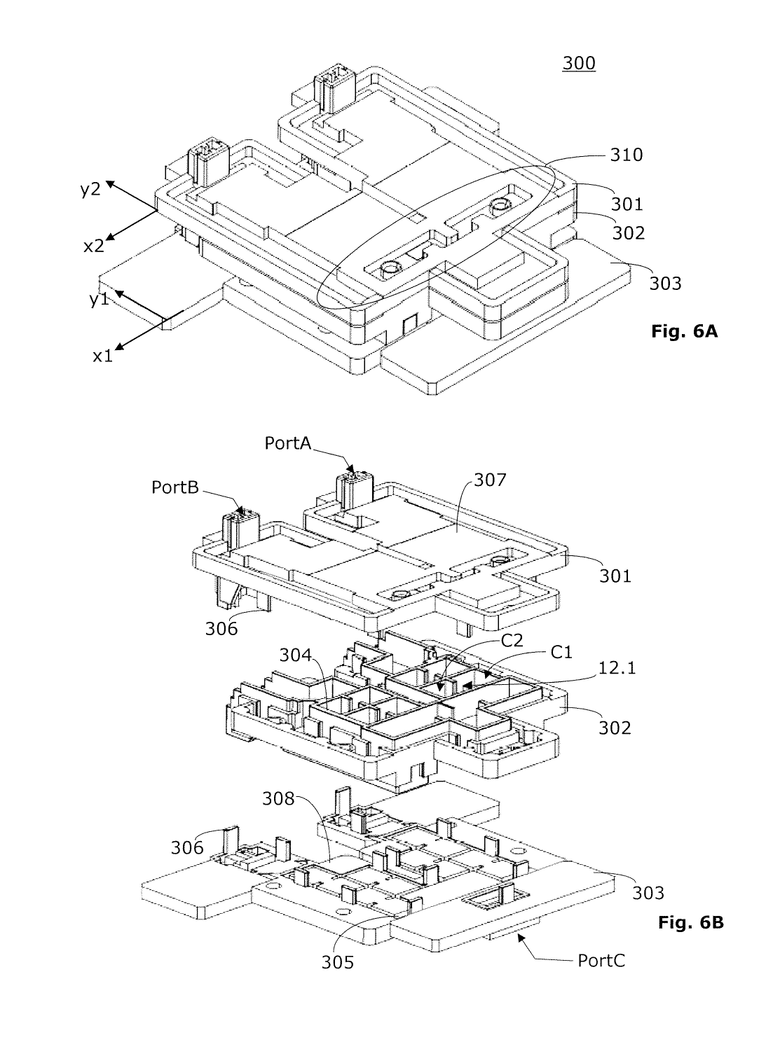

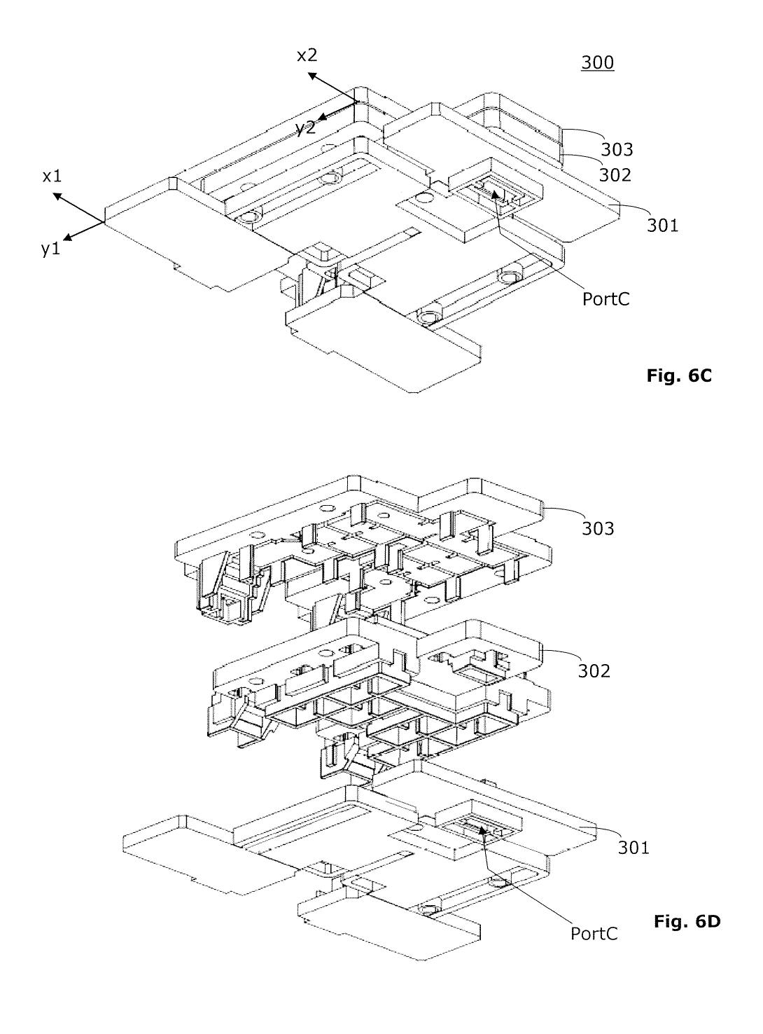

A filter is an electrical “circuit” that is employed to process (wave) signals. The function of the filter can be described by what is called a filter function. An embodiment of a pass-band filter (cf. FIGS. 6A through 6D) will be described hereinafter, to illustrate how the invention can be actually implemented.

According to the present invention, a plastic material is used to form two or more metallized filter parts which give the best prerequisite for excellent alignment and registration. These filter parts are fabricated by means of injection molding. Since one has to be able to remove the hardened plastic parts from the mold, the 3-dimensional structure of the plastic parts has to be designed accordingly. Care has to be taken when designing the plastic parts and the respective molds that both can be separated without the parts being damaged. This, however, sets certain limits as far as the design of the 3-dimensional parts is concerned. Fabricating an injection molded filter just using one filter part is thus impossible, since one would not be able to provide appropriate cavities.

According to the present invention, simple shapes following standard plastic-molding design rules are preferred. This is, however, possible only when the filter is designed to comprise two or more parts that can be assembled later. The most basic embodiment comprises two filter parts that are assembled to form the filter. More sophisticated filters can be realized by a central filter part that has cavities on two opposite sides and by two (outer) filter parts serving as covering plates.

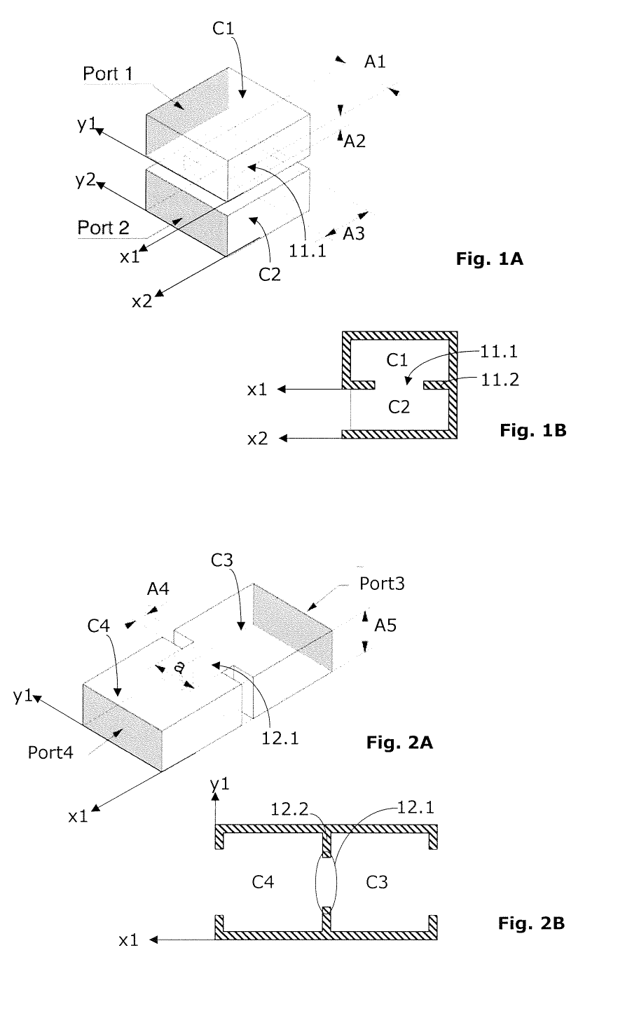

FIGS. 1A, 1B and FIGS. 2A and 2B depict the basic coupling openings involved.

A first building block of the present invention is depicted in FIGS. 1A and 1B. In FIG. 1A two cavities C1 and C2 are depicted. These cavities C1 and C2 are situated on two adjacent levels, as indicated by the x1, y1 and x2, y2 coordinate systems. That is, the first cavity C1 sits on top of the second cavity C2. The cavities C1 and C2 are formed when assembling plastic molded filter parts, as will be described later. The two cavities C1, C2 are coupled by a central capacitive iris 11.1, as depicted in FIGS. 1A and 1B. The iris 11.1 is an opening in a wall 11.2 between the two levels x1, y1 and x2, y2. The size, shape and position of the iris 11.1 has an impact on the coupling efficiency when coupling a wave from the first cavity C1 to the second cavity C2, or vice versa. As indicated in FIG. 1A, the iris 11.1 may have a rectangular shape having a size of A1×A3. Preferably, the iris 11.1 is quadratic, i.e. A1=A3. The thickness A2 of the wall 11.2 between the two cavities C1 and C2 also has an impact on the coupling efficiency. It is to be noted that the cavities do not have to be in overlying registration to one another. The FIGS. 1A and 1B just show a preferred embodiment where both cavities are co-centrically arranged.

In the frequency regime, the iris 11.1 serves as a capacitive junction between the first cavity C1 and the second cavity C2. The coupling between the two cavities C1 and C2 is predominantly an E-field coupling.

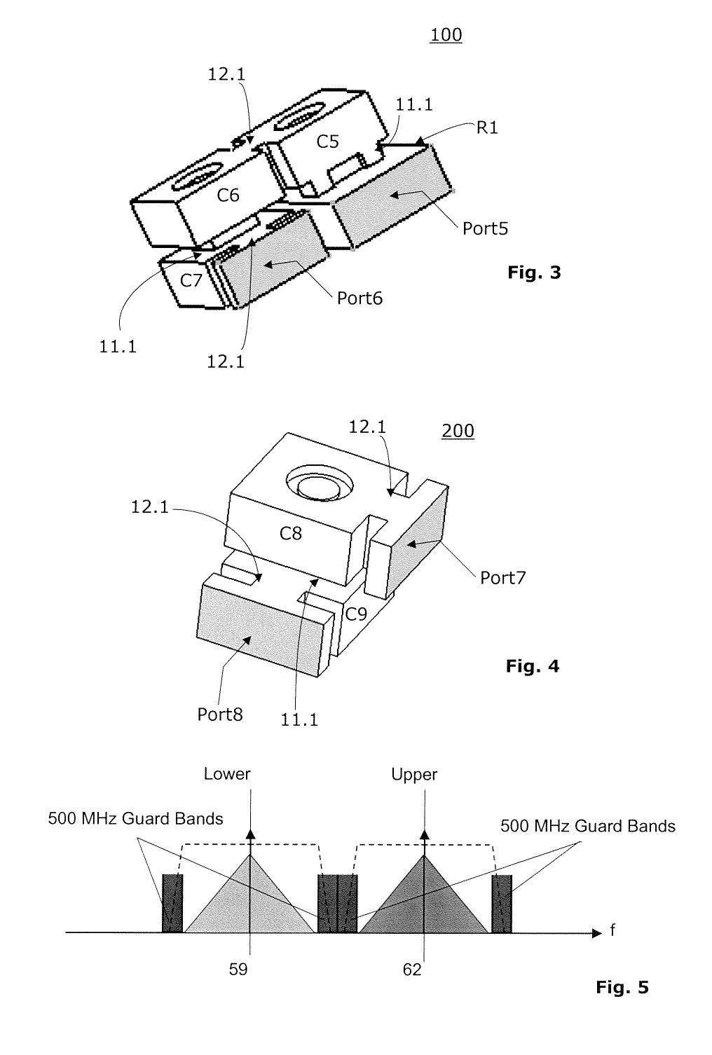

Using stacked cavities, as depicted in FIGS. 1A and 1B, for instance, being coupled by a central capacitive iris 11.1, the filter footprint can be reduced. Additionally, since this configuration allows rotating the two cavities C1, C2 around a coupling aperture axis, the waveguide ports (Port1 and Port2) to an antenna and an front-end circuit module can be placed in more convenient positions for an optimized front end module floor plan layout. The Port1 and Port2 in FIG. 1A are actually used as reference plans for electrical calculations. In a real implementation, inductive apertures would be situated at these ports (as illustrated in FIG. 4, for instance).

A second building block of the present invention is depicted in FIGS. 2A and 2B. In FIG. 2A two cavities C3 and C4 are depicted. These cavities C3 and C4 are situated on the same level, as indicated by the x1, y1 coordinate system. That is, the cavity C3 sits on the same level as the second cavity C4. The cavities C3 and C4 are formed when assembling plastic molded filter parts, as will be described later. The two cavities C3, C4 are coupled by a central inductive aperture 12.1, as depicted in FIGS. 2A and 2B. The size, shape and position of the aperture 12.1 has an impact on the coupling efficiency when coupling a wave from the cavity C3 to the cavity C4, or vice versa. As indicated in FIG. 2A, the aperture 12.1 may have a rectangular shape having a size of a ×A5. The thickness A4 of the wall 12.2 between the two cavities C3 and C4 also has an impact.

In the frequency regime, the aperture 12.1 serves as an inductive junction between the cavity C3 and the cavity C4. The coupling between the two cavities C3 and C4 is predominantly an H-field coupling. As illustrated in FIG. 2A, the cavity C3 has a port, designated as Port3, and the cavity C4 has a port, designated as Port4. The Port3 and Port4 in FIG. 2A are actually used as reference plans for electrical calculations. In a real implementation, capacitive irises or inductive apertures would be situated at these ports or in the respective cavities (as illustrated in FIG. 3, for instance).

In order to be able to realize a filter, a plurality of coupled resonator cavities have to be provided. The coupling of the cavities can be done as depicted in FIGS. 1A through 2B, for instance.

Further embodiments comprising a plurality of coupled resonator cavities are depicted in FIGS. 3 and 4. In FIG. 3 a filter assembly 100 is shown. The filter assembly 100 comprises three cavities C5, C6, and C7 and an input region R1. A wave is coupled via a Port5, the input region R1 and an iris 11.1 (capacitive junction) up into the cavity C5. The wave is then coupled via an aperture 12.1 (inductive junction) into the cavity C6 and from there via another iris 11.1 (capacitive junction) into the cavity C7. There is another aperture 12.1 (inductive junction) at the output side of the cavity C7. The output is in FIG. 3 referred to as Port6.

In FIG. 4 another possible filter assembly 200 is shown. The filter assembly 200 comprises two cavities C8 and C9. A wave is coupled via a Port7 and an aperture 12.1 (inductive junction) into the cavity C8. The wave is then coupled via an iris 11.1 (capacitive junction) into the cavity C9 and from there via another aperture 12.1 (inductive junction) towards a Port8.

In the following, we focus on the design of compact millimeter wave filters as one of the key elements of a Gigabit Wireless communications system. It is, however, to be understood that the invention described and claimed herein can also be used in connection with other types of filters and communication systems.

A point-to-point communication system is presented being intended to operate in the license-exempt 60 GHz spectrum, as approved by the U.S. Federal Communication Commission (FCC). A full duplex Gigabit operation can be achieved using a transmit/receive diplexer filter assembly 300 (cf. FIGS. 6A through 6D) of very high rejection (preferably >80 dB) in the adjacent band allowing to simultaneously transmit data in both directions.

FIG. 5 shows a possible subdivision of the frequency band. The frequency span used by the present filter assembly 300 is split up into two bands (59 GHz and 62 GHz) for transmit and receive with appropriate 500 MHz guard-bands for allowing oscillator drift and temperature-dependencies and production spread of passive components. The filter assembly 300 is the main circuit that isolates the receiver inside the transceiver from the power transmitted by the transceiver's transmitter.

In the following sections, the filter assembly 300 is described. The filter assembly 300 comprises several of the building blocks of FIGS. 1A through 4.

The filter assembly 300 comprises a plurality of coupled waveguide resonators (e.g. C1 and C2, as depicted in FIG. 6B). The cavities serve as waveguide resonators. According to the present invention, these cavities are arranged at least on two levels x1, y1 and x2, y2, as indicated in FIG. 6A. In order to provide for the coupling of the resonators, there are openings in the walls 304 between the cavities. These openings may serve as capacitive junctions or inductive junctions, as discussed in connection with FIGS. 1A through 4. In the present embodiment, the filter assembly 300 comprises three plastic molded filter parts 301, 302, and 303. In FIG. 6A these three filter parts 301, 302, and 303 are assembled.

In FIG. 6B, the three parts 301, 302, 3003 are shown prior to being assembled. As indicated in FIG. 6B, the filter part 302 comprises walls 304 which are essentially perpendicular to the planes x1, y1 and x2, y2. These walls form a grid-like structure. This grid-like structure is herein referred to as honey-comb structure. In the present embodiment, the walls 304 define rectangular chambers. Preferably, these chambers have a quadratic footprint in the planes x1, y1 and x2, y2. The quadratic footprint has the advantage that the various cavities can be easily placed next to each other. It is a further advantage of the quadratic footprint that the walls 304 between adjacent chambers have essentially the same thickness (thickness A4 in FIG. 2A, for example). The employment of cavities with quadratic footprint enables filter assemblies being very densely packed.

The filter part 302 further comprises an intermediate floor (not visible in the Figures). This floor runs parallel to the levels x1, y1 and x2, y2. There is a honey-comb structure on each side of the intermediate floor. The upper honeycomb structure is visible in FIG. 6B. The lower honey-comb structure is visible in FIG. 6D.

The filter parts 301 and 303 each comprise a floor, as well. The backside 307 of the floor of the filter part 301 and the upper part 308 of the floor of the filter part 303 are visible in FIG. 6B. It is advantageous to provide depressions or grooves 305 in these floors to receive the walls 304 of the filter part 302 when the filter parts 301, 302, 303 are assembled. This allows cavities to be formed that are completely enclosed, expect for those walls where there is an iris or an aperture 12.1. In FIG. 6B the apertures 12.1 between various of the cavities on one level are visible. The irises, however, are not visible since they are located in the intermediate floor of the filter part 302.

Preferably, at least some of the walls 304 and grooves 305 provide for a mechanical and an electrical interconnection. In order for a reliable electrical connection to be established, the size and shape of the walls 304 and grooves 305 are chosen so that a metallization on the walls 304 and a metallization on the grooves 305 come in contact with each other. Preferably, the two metallizations are welded together during the press-fitting process by cold-welding action.

At least some of the filter parts 301, 302 of the present embodiment may comprise protruding elements 306. These elements 306 stretch out in a direction being essentially perpendicular to the levels x1, y1 and x2, y2. On the opposite side there are complementary receiving sections (e.g. grooves or the like). When assembling the filter parts 301-303, these protruding elements 306 are received by these receiving sections. This combination of protruding elements 306 and complementary receiving sections may be employed to provide for a precision of the relative position of the parts 301-303 of the filter assembly 300. It is, however, also possible to define the relative position of the filter parts by other features of their 3-dimensional structures.

In a preferred embodiment, the walls 304 and grooves 305 are designed so that they click in when a certain pressure is applied. This allows to ensure that a predefined distance between the parts 301-303 is maintained. This provides for a perfect fit and the assembling can be done in a glue- and solder-less press-fitting process. The protruding elements 306 may also be designed so as to click in when a certain pressure is applied.

In a preferred embodiment, the walls 304 and grooves 305 are placed in locations within the active area (electrically relevant area) of the overall filter assembly 300. In this case they have to be designed so that they do not negatively influence the wave inside the assembly.

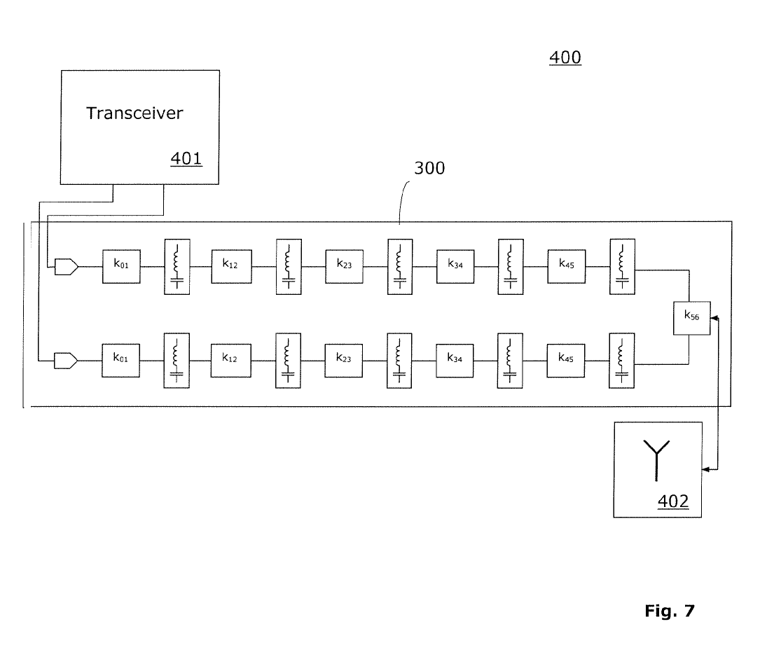

The waveguide ports (PortA, PortB, PortC) are placed in convenient positions allowing the filter assembly 300 to be coupled to an antenna (402 in FIG. 7, for example) on one side and a front-end module (e.g. a LTCC front-end hybrid module 401 in FIG. 7) on the other side. In the present embodiment, at least one of the ports (PortC in the present embodiment) is realized as choke-flange. It is an advantage of a choke-flange that no RF-critical galvanic contacts to other circuits are required.

In a preferred embodiment (cf. FIGS. 6A through 6D), the filter assembly 300 comprises a Tee junction 310. The Tee junction 310 has one output port PortC for establishing a connection to an antenna (402 in FIG. 7, for example). The Tee junction 310 is employed in order to combine two branches of the filter with said PortC.

The plastic molded filter parts 301-303 are at least partially covered by a metal layer in order to guide the waves in an appropriate fashion. Low-loss, highly reproducible performance is given if a high-density metallization is applied. In some of the embodiments presented herein, the walls 304 have a thickness between 0.1 mm and 1 mm and preferably between 0.3 mm and 0.5 mm. The thickness of the metal layer is between 1 μm and 50 μm and preferably between 3 μm and 20 μm. It is obvious, that these indications of measurement vary when designing a filter assembly for employment in another frequency regime.

According to the present invention, a plastic material is used to form two or more metallized filter parts. This approach gives the best prerequisite for excellent alignment and registration. Simple shapes following standard plastic-molding design rules are preferred.

This is best accomplished by a central filter part 302 (cf. FIGS. 6A through 6D) that has honey-comb structures for forming cavities on two opposite sides and two filter parts 301 and 303 serving as covering plates.

Using stacked cavity structures coupled by a central capacitive irises, as depicted in FIG. 1A for instance, reduces the filter assembly's footprint. Additionally, since this configuration allows rotating the cavities around the coupling aperture axis, the waveguide ports to an antenna and an LTCC front-end hybrid module can be placed in more convenient positions for an optimized front end module floor plan layout. This supports the realization of compact GHz modules.

In another preferred embodiment, at least some of the cavities comprise elements for post production tuning.

The high selectivity required by a communication system in accordance with the present invention may be achieved by a straight-forward Chebychev filter. The respective diplexer filter assembly 300 consists of two 10th order bandpass filters connected by a Tee junction 310. Each of the filters is composed of ten coupled resonators of appropriate dimensions. In this embodiment, the coupling elements are alternating capacitive and inductive apertures, as illustrated in FIGS. 6A through 6D. In the present embodiment, the coupling element into the first resonator is a cut-off ridged waveguide-section.

Preferably, each of the filter parts is built up as 3D-Model in a Finite Element solver and as theoretical model in a microwave simulation tool. As starting values the irises and cavities may be dimensioned according to pre-established design curves. The ideal model of the filter parts educates the 3D structures by a relaxation process. In this way all interdependencies like de-tuning of cavity resonant frequencies by varying aperture sizes throughout the filter and tuning element influence of aperture coupling coefficients can be taken into account. By a repetitive application of this process, all cavities and couplings can be optimized.

Preferably, the individual cavities are designed such that, when taking the influence of the inductive and/or capacitive junctions into consideration, they all have essentially the same resonance frequency.

The inventive concept presented herein allows to make very compact high selectivity diplexer filters for Gigabit millimeter wave radio units, for instance. Low-loss, highly reproducible performance is given if a high-density highly conductive metallization (e.g. gold) is applied and a press-fitting assembly process is used to combine the filter parts into one filter assembly.

According to the present invention, the resulting accuracy of finalized parts is in the order of ±5 μm, which is prerequisite for filter applications around 60 GHz or higher. The present invention can thus be used in millimeter-wave radio terminals or other millimeter-wave communication systems, for instance. The invention can also be used in sub-millimeter communication systems.

It is advantageous to use novel high-temperature thermoplastic polymers (like polyphenylene sulfide (PPS), metallized by a vacuum deposition method, in order to realize filter assemblies. Similar results may be achieved by using Liquid Crystal Polymers (LCP) or polyetherimide (PEI) materials. The metallization is applied before the filter parts are assembled.

In a preferred embodiment, the filter assembly comprises choke flanges as blind mate connectors allowing the filter assembly to be easily integrated into a (millimeter wave) communication front end without the need for special alignment pins, or the like. This simplifies the front end assembly.

The filter assemblies lend themselves to high production and reliability as well as cost savings.

The molded filter parts may provide for holes, standoffs and numerous other physical features which are molded into the structures eliminating the need for drilling, cutting and other treatments. The injection molding gives the filter parts a true three-dimensional layout.

The filter parts can be equipped with special interconnect features (e.g. protruding elements and receiving sections) that allow the filter parts to be assembled to form a filter assembly. This offers the advantage of easy handling and high speed production.

It was described that the present invention provides a product which lends itself to automatic injection molding so that mass production can be obtained with low cost. In this manner, filter assemblies can be produced having almost any three-dimensional design.

It is an advantage of the (injection) molding process, that the mold itself, once it is on a certain process temperature, has a stable size whereas the milling process used for making conventional filters is known to be temperature dependent. Furthermore, the molding process does not show any noticeable wear of the tools. It is another advantage that one tool can be used for making a large quantity of filter parts.

According to the present invention, the application of optimized material combinations allows to obtain light-weight (hence cost efficient mechanical structures) and volume production efficient components.

The filter assembly, according to the present invention, may be employed in a communication system, such as a millimeter-wave communications system. An example of a millimeter wave front end of such a communication system 400 is illustrated in FIG. 7. This filter assembly 300 may for instance be connected to an antenna 402 to separate the transceiver's transmission part (transmitter) from the transceiver's receiving part (receiver). The assembly 300 is particularly well suited for usage in connection with a full-duplex transceiver 401. It is advantageous to employ the inventive filter assembly 300 in an FDD (Frequency Division Duplex) communication system being designed for operation at frequencies above 2 GHz until about 100 GHz.

The transceiver 401 in the present embodiment comprises a transmitter part and a receiver part, as mentioned above. In an FDD communication system, the transceiver 401 is operated as transmitter and receiver at the same time, whereby the transmitter and receiver use different frequency bands (cf. FIG. 5, for instance). The receiver has to be protected at its input side by means of a high selectivity transmit/receive filter (such as the filter assembly 300, for example) to make sure that the high energy signals emitted by the transceiver's transmitter are not coupled into the receiver. Since the antenna 402 only has a broadband gate, the emitted signal has to be guided parallel to the filter 300 and is then coupled by means of a Tee junction. In order to make sure that this transmission path cannot be passed by the received signal, the transmission path has to show a stop-band behavior. On the other hand, the receiver path has due to the respective bandpass behavior in the reception band a stop-band for the transmitted signal. Since the opposite station of the communication system has to fulfill the same criteria, just with alternate frequency bands, one prefers diplex filters that are designed so as to combine the desired bandpass and stop-band characteristics. In such a case, however, the filter flanks have to be very steep to provide for the necessary isolation of the two pass bands. This in turn defines the number of resonators required in each of the filters, whereby it is to be noted that the number of resonators also depends on the filter type chosen.

In the present embodiment, the filter assembly 300 comprises two branches, where each branch has five resonators (note that in FIGS. 6A through 6D, each branch of the filter assembly 300 has ten resonators). In FIG. 7, the filter is depicted as schematic block diagram where each of the resonators (cavities) is illustrated by means of an inductance and a capacitor. The inductive or capacitive coupling between two adjacent cavities is illustrated by respective coupling elements (k₀₁, k₁₂, and so forth).

The diplex filter thus serves as interface between antenna and transceiver and has to be easily and reliably combinable. Oftentimes, the filter is a heavy and mechanically complicated construction to absorb external forces applied to the antenna and to prevent a change of the filter characteristics. These problems are avoided by the invention presented herein since the filter assembly is very small and compact. It does not require any standard connectors and tolerates mechanical deviations at the interface between the antenna and the filter assembly.

1. A filter (100; 200; 300) with several waveguide resonators (100; 200; 300) comprising:
a plurality of cavities (C1-C9) serving as said waveguide resonators, said cavities (C1-C9) being arranged at least on two levels (x1, y1; x2, y2) of said filter (100; 200; 300),
a first opening (11.1) in a wall (11.2) between a first (C1) and a second (C2) of said cavities (C1-C9), said opening (11.1) serving as capacitive junction between said first cavity (C1) and said second cavity (C2),
a second opening (12.1) in another wall (12.2) between a third (C3) and a fourth (C4) of said cavities (C1-C9), said opening (12.1) serving as inductive junction between said third cavity (C3) and said fourth cavity (C4), wherein said filter (100; 200; 300) is a filter assembly (100; 200; 300) with at least two plastic molded filter parts (301, 302, 303) defining said cavities (C1-C9), when said two plastic molded filter parts (301, 302, 303) are assembled,
said plastic molded filter parts (301, 302, 303) being at least partially covered by a metal layer.

2. The filter (100; 200; 300) of claim 1, comprising a choke structure (PortC) serving as at lease one port of the group of ports consisting of: an input/output port, an input port or an output port.

3. The filter (100; 200; 300) of claim 1, wherein said first opening (11.1) is an iris having a size that defines a coupling intensity between said first cavity (C1) and second cavity (C2), the coupling being predominantly an E-field coupling.

4. The filter (100; 200; 300) of claim 1, wherein said second opening (12.1) is an aperture, the coupling being predominantly an H-field coupling.

5. The filter (100; 200; 300) according to claim 1, wherein at least some of the cavities (C1) on a first (x1, y1) of said two levels are stacked above some of the cavities (C2) on a second (x2, y2) of said two levels.

6. The filter (100; 200; 300) of claim 5, wherein said first opening (11.1) is situated in a wall (11.2) that separates said two levels (x1, y1; x2, y2) and said second opening (12.1) is situated in a wall (12.2) within one of said two levels (x1, y1).

7. The filter (300) according to claim 1, comprising a T-junction (310), preferably an H-plane waveguide junction, arranged proximate the port (PortC) of said filter assembly (300).

8. The filter (300) of claim 7, comprising two bandpass branches feeding said T-junction (310).

9. The filter (100; 200; 300) according to claim 1, serving as diplex filter.

10. The filter (100; 200; 300) according to claim 1, being designed for operation in the Gigahertz frequency range to higher frequencies.

11. A communications system (400) being designed for operation in the Gigahertz frequency range to higher frequencies, said communication system (400) comprising a front-end module (401), a high-gain antenna (402), and a filter (300), comprising:
a plurality of cavities (C1-C9) serving as waveguide resonators, said cavities (C1-C9) being arranged at least on two levels (x1, y1; x2, y2) of said filter (300),
a first opening (11.1) in a wall (11.2) between a first (C1) and a second (C2) of said cavities (C1-C9), said opening (11.1) serving as capacitive junction between said first cavity (C1) and said second cavity (C2),
a second opening (12.1) in another wall (12.2) between a third (C3) and a fourth (C4) of said cavities (C1-C9), said opening (12.1) serving as inductive junction between said third cavity (C3) and said fourth cavity (C4), characterized in that said filter (100; 200; 300) is a filter assembly (100; 200; 300) with at least two plastic molded filter parts (301, 302, 303) defining said cavities (C1-C9), when said two molded filter parts (301, 302, 303) are assembled,
said plastic molded filter parts (301, 302, 303) being at least partially covered by a metal layer.

12. The communication system (400) of claim 11, wherein said filter (300) comprises a choke structure (PortC) serving as a port.

13. The communication system (400) of claim 11, wherein said filter (300) is mounted on said high-gain antenna (402).

14. The communication system (400) of claim 13, wherein said choke structure (PortC) provides for a non galvanic contact to said high-gain antenna (402).

15. A method for making a filter (100; 200; 300) with several waveguide resonators comprising the steps:
injection-molding at least two plastic molded parts of the filter assembly in perfect fit, including a central plastic molded part comprising cavities, using a tool that can be used for making a large quantity of plastic molded parts;
applying a metallization before the plastic molded parts of the filter assembly are assembled so that the plastic molded parts are at least partially covered by a metal layer; and
assembling the plastic molded parts by a press-fitting process, so that the filter (100; 200; 300) comprises a plurality of cavities (C1-C9) being arranged at least on two levels (x1, y1; x2, y2) of said filter (300).

16. The method of claim 15, wherein the metallization is applied by a process selected from the group of metallization processes consisting of: a metal plating process, and a metal deposition process.

17. The method of claim 15, wherein high performance thermoplastics are used for the injection-molding

18. The filter (100; 200; 300) of claim 1, comprising a choke structure (PortC) serving as an input port.

19. The filter (100; 200; 300) of claim 1, comprising a choke structure (PortC) serving as an output port.
